(19) United States
(12) Patent Application Publication
(10) Pub. No.: US 2007/0274483 A1
(43) Pub. Date: Nov. 29, 2007

(54) System and method for providing telecommunication services free of charge

(76) Inventor: Philip Robert Shapiro, Simi Valley, CA (US)

Correspondence Address: PHILIP H. BURRUS, IV, 460 Grant Street, Atlanta, GA, 30312, US

(21) Appl. No.: 11/418,229

(22) Filed: May 4, 2006

(51) Int. Cl. H04M 15/00

(52) U.S. Cl. 379/114.12

(57) ABSTRACT

A system and method for providing telecommunication services free of charge to a customer are provided. In one embodiment, a customer receives free of charge telecommunication services, which may include telephone service, voice mail service, facsimile service, or other services, in exchange for agreeing to listen to one or more targeted advertisements prior to use of the services. The customer provides personal interest information to the service provider, which may be correlated with targeted advertising. For example, when making an outbound telephone call, a service provider determines the number of the outbound call and retrieves personal interest information associated therewith. The service provider then selects a targeted advertisement corresponding to the personal interest information and delivers it to the source of the outbound call. Upon completion of the advertisement, the customer is given options of receiving additional information or completing the call.

### BACKGROUND

1. Technical Field

This invention relates generally to a system and method for providing telecommunication services, such as voice over Internet protocol telephone service, to a customer, and more specifically to a system and method for providing advertisement-based telecommunication services free of charge to a customer.

2. Background Art

From the advent of the telephone until just the recent past, people wishing to obtain voice-based telecommunication services would arrange to do so as follows: They would contact their local telephone company, arrange for a service technician to visit their home, and have telephone wiring and services installed. They would then make monthly payments to the telephone company in exchange for the usage of the telecommunication services. These payments would vary from month to month, depending upon usage. For example, long distance telephone calls made to destinations outside the caller's service area generally included increased per-minute fees. During months where extensive long distance talk time was used, an unexpectedly high telephone bill may appear.

With the advent of mobile telephone service, many mobile telephone service providers began to offer flat rate plans that include a preset, packaged amount of usage. This usage, generally offered as so many minutes of talk time per month, included both long distance and local telephone calls. Further, in addition to voice-based services, mobile telephone service may include other features, such as the ability to send text messages or pictures. Consequently, many people began to switch from traditional, landline service to mobile telephone service to avoid the surprise of an expensive bill when a large number of long distance minutes were used. The flat rate package offers many users a more economical mode of voice-based communication.

In an attempt to lure subscribers with even more economical service offerings, some telecommunication service providers have even begun to offer services for reduced, or even free, rates. By way of example, in exchange for obtaining free or subsidized services in some systems, subscribers must listen to advertisements prior to placing a call. When the subscriber places an outbound call, he must listen to a fixed amount of outbound advertising to obtain a fixed amount of free or subsidized communication time. Similar to placing a quarter into a pay phone for three minutes of talk time, a subscriber may have to listen to one advertisement for three minutes of talk time, two advertisements for six minutes of talk time, and so forth. Once the subscriber has listened to a number of messages equivalent to his desired talk time, he is connected with the call destination. Once the earned talk time has expired, the call is disconnected. In some systems, to talk beyond the minutes earned by listening to advertisements, charges begin to accrue.

Such “talk time per minutes of advertising listened to” have several problems associated therewith. First, suppose that a subscriber wants to place a ten-minute call to his mother. To do so, he may have to listen to four thirty second advertisements. If his mother's line is busy, or if his mother is not available at the time of the call, his advertisement-listening time investment is lost. Next, where the subscriber underestimates the require talk time, either his call may be prematurely disconnected or he may face unwanted charges on the next monthly bill.

There is thus a need for an improved system of offering telecommunication services free of charge to a customer.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an outbound, free of charge call in accordance with embodiments of the invention.

FIG. 2 illustrates a method of making an outbound, free of charge call in accordance with embodiments of the invention.

FIG. 3 illustrates an inbound call to a free of charge telecommunication service in accordance with embodiments of the invention.

FIG. 4 illustrates a method of making an inbound call to a free of charge telecommunication service in accordance with embodiments of the invention.

FIG. 5 illustrates an interrupt during a telephone call in a free of charge telecommunication service in accordance with embodiments of the invention.

FIG. 6 illustrates a method of accommodating an interrupt during a telephone call in a free of charge telecommunication service in accordance with the invention.

FIG. 7 illustrates a system for providing free of charge telecommunication services in accordance with embodiments of the invention.

FIG. 8 illustrates one method for establishing free of charge telecommunication services in accordance with the invention.

FIG. 9 illustrates one embodiment of facilitating an outbound call in a free of charge telecommunication service in accordance with the invention.

FIG. 10 illustrates one embodiment of facilitating an inbound call to a free of charge telecommunication service in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to the provision of free of charge telecommunication services. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors, components, modules, and unique stored program instructions that control the one or more systems to implement, in conjunction with certain non-processor circuits, some, most, or all of the functions of providing free of charge telecommunication services as described herein. The components and modules circuits may include, but are not limited to, voice over Internet protocol voice to data switches and routers, software modules configured to run in computer systems, databases and associated computer systems, World Wide Web servers, and telephone interface circuitry. As such, these functions may be interpreted as steps of a method to perform the provision of free of charge telecommunication services. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” In this document, relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

The present invention offers a method and system for providing free of charge telecommunication services to a customer base. An offer to establish the free of charge services is contingent upon a prospective customer completing a questionnaire or customer profile. The questionnaire or profile includes personal interest information, such as hobby information, occupational information, vacation preference information, recreational information, and the like. Upon receipt of the personal interest information, the service provider associates this information with a particular caller or telephone number.

Advertisers then provide interest-targeted advertising to the service provider. When a customer uses the telecommunication services, the service provider associates the personal interest information with the interest-targeted advertising. In so doing, the service provider may deliver targeted advertising to a particular customer. As target advertising is generally more valuable to manufacturers and merchants, a service provider in accordance with the invention is able to charge higher advertising fees than would be charged in a non-targeted system. These higher fees, which enable the telecommunication service to be offered free of charge to a customer, enable the customer to place calls of varying lengths upon listening to a single, targeted advertisement, in contrast to prior art solutions of listening to varying numbers of commercials. In one embodiment, a caller may place a call, be it for ten minutes or fifty minutes, by listening to a single call. In prior art systems, by contrast, the caller may have to listen to as many as eighteen advertisements for a fifty-minute call.

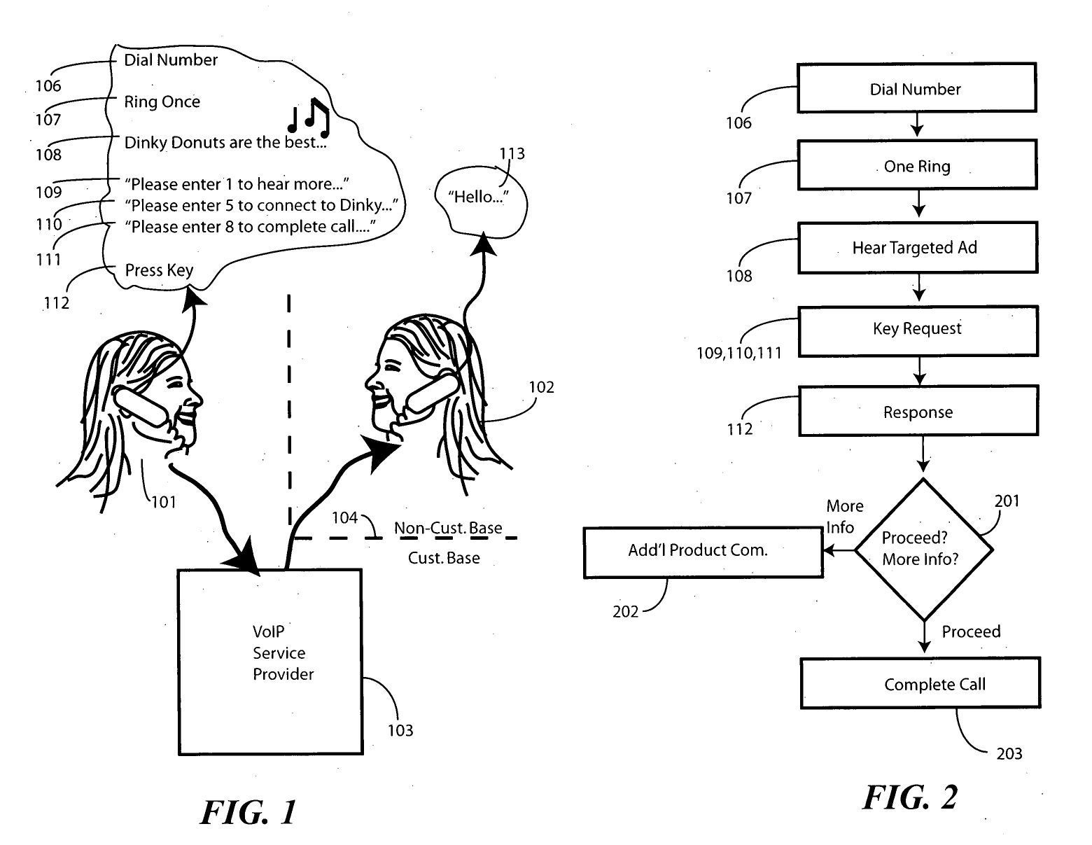

Turning now to FIG. 1, illustrated therein is an exemplary outbound call in accordance with one embodiment of the invention. A caller 101 receiving free of charge telecommunication services places a voice call to a call recipient 102. The call recipient 102, in this exemplary embodiment, is not within the customer base receiving the free of charge telecommunication services, as is delineated by 104. Note, however, that the steps executed by caller 101 are generally the same for all calls, regardless of whether the call recipient 102 is also receiving free of charge telecommunication services.

The caller 101 first dials the telephone number of the call recipient 102, as is indicated at 106. The caller 101, in exchange for receiving free of charge telecommunication services, has agreed to listen to targeted advertising prior to the call being connected. As such, the caller 101 first hears a predetermined number of rings at 107. The predetermined number of rings 107 is indicative of the step of dialing 106 being successfully accomplished. In the exemplary embodiment of FIG. 1, the caller 101 hears one ring.

The caller 101 then hears an advertisement, as indicated at 108, that corresponds to personal interest information submitted by the caller 101 to the service provider 103. By way of example, in the illustrative embodiment of FIG. 1, when the caller 101 established service, the caller 101 indicated that he enjoyed snacking on donuts. As such, the service provider has delivered an advertisement for donuts. This advertisement may last between ten and fifteen seconds.

Once the advertisement is completed, the service provider 103 requests that the caller 101 select from a plurality of options. Each option will have a response associated therewith. The caller 101, in one embodiment, may make the response by either pressing a button on the telephone or by saying a word or number. While the options may be consistent at the end of each advertisement, the responses for each may not. To ensure that the caller 101 is listening, the service provider 103 may request a random response to each option. For example, in one call, to respond to the first option, the caller 101 may be requested to say “seven” or press the seven button, while in another call, to respond to the first option, the caller may be requested to say “two” or press the two button. These responses may be selected at random and delivered at the end of the advertisement to ensure that the caller 101 does not prematurely end the advertisement.

The various options may include hearing more information about the advertised product or service, being connected directly to the source of an advertised product or service, receiving more information through alternate media such as e-mail, voice mail or facsimile, or completing the call. Looking at the exemplary embodiment of FIG. 1, at 109, the caller 101 is requested to press or say “one” to hear more information about the product. At 110, the caller 101 is requested to press or say “five” to be connected to the donut company. At 111, the caller 101 is requested to press or say “eight” to complete the call.

The caller 101 then delivers the response at 112. Where the caller 101 selected to receive more information, the caller 101 may hear an additional advertisement or may be presented with other options, for example hearing a set of technical specifications. This process continues until the caller 101 selects the complete call option. Once this occurs, the service provider 103 connects the call with the call recipient 102. The call then takes the form of a conventional, non-time limited telephone call once the call recipient 102 answers, as is shown at 113.

Turning now to FIG. 2, illustrated therein is a flow chart illustrating the steps occurring in FIG. 1. At step 106, the outbound caller (101) dials the number. At step 107, the caller (101) hears a predetermined number of rings. At step 108, the caller (101) hears the targeted advertisement. At 109,110,111, the service provider (103) provides a list of options and responses. The responses may be randomly selected key requests for the caller (101) to execute to move to the next step.

At step 112, the caller (101) delivers the response to the service provider (103). At decision 201, the service provider (103) determines whether the caller (101) has selected to receive more information or to complete the call. Where the “receive more information” option has been selected, the service provider (103) may deliver additional information at step 202. Where the caller (101) has selected to complete the call, the service provider (103) does so accordingly.

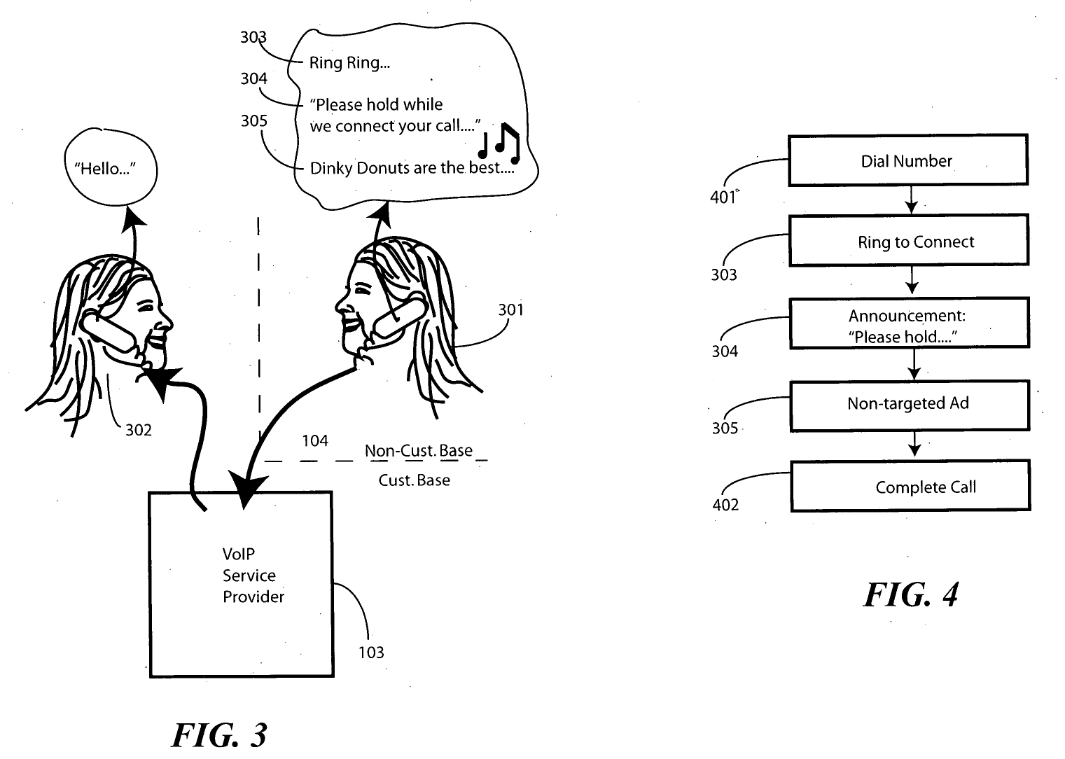

Turning now to FIG. 3, illustrated therein is an exemplary in-coming call in accordance with one embodiment of the invention. A caller 301, who is outside the customer base receiving free of charge telecommunication services as delineated by 104, places a voice call to a call recipient 302 who is receiving free of charge telecommunication services from a service provider 103. The process is similar to the outbound call illustrated in FIG. 1. One difference, however, is that the service provider 103 does not have personal interest information from the caller 301, as the caller 301 is outside the customer base. Thus, non-targeted advertising is delivered to the caller 301, rather than the directed advertising shown in FIG. 1.

In FIG. 2, the caller 301 first dials the number of the call recipient 302. As shown at 303, the caller 301 then hears a predetermined number of rings while he is being connected with the service provider 103 to ultimately be connected with the call recipient 302. As the call recipient 302 is receiving telephone services free of charge, the service provider 103 may receive money to operate the telecommunication services from advertisers. Thus, the caller 301 may be delivered advertising as part and parcel of completing a telephone call with the call recipient 302.

The caller 301, as shown at 304, may first hear an informational announcement about what will transpire. For instance, the caller 301 may hear an announcement such as, “Please hold while we connect your call . . . ” The caller 301 is then delivered a non-targeted advertisement at 305. Once the advertisement is complete, the inbound telephone call is completed.

Turing now to FIG. 4, illustrated therein is a flow chart of the steps associated with an inbound call in accordance with the invention, such as the call illustrated in FIG. 3. At step 401, the caller (301) dials the number of a call recipient (302) receiving free of charge telecommunication services from the service provider (103). At step 303, the caller (301) hears a number of rings indicating that the call is being processed.

At step 304, the caller (301) hears an informational announcement indicating that the call is being completed. At step 305, the caller (301) hears non-targeted advertising. Once the advertisement is completed, the call is connected at step 402.

In addition to inbound and outbound calls, calls may be interrupted in accordance with the invention. For example, a call may be placed on hold. Alternatively, call waiting may be activated, wherein a first caller is placed on hold while a second caller is connected. Additionally, where three-way calling is offered, a first caller may be placed on hold while other parties connect. In one embodiment of the invention, when any of these interruptions occurs, the caller placed on hold may hear additional, non-targeted advertising. By way of example, this non-targeted advertising may include information relating to musical productions or cinematographic productions. For instance, the caller on hold may hear the latest music single information or information on the latest movie releases.

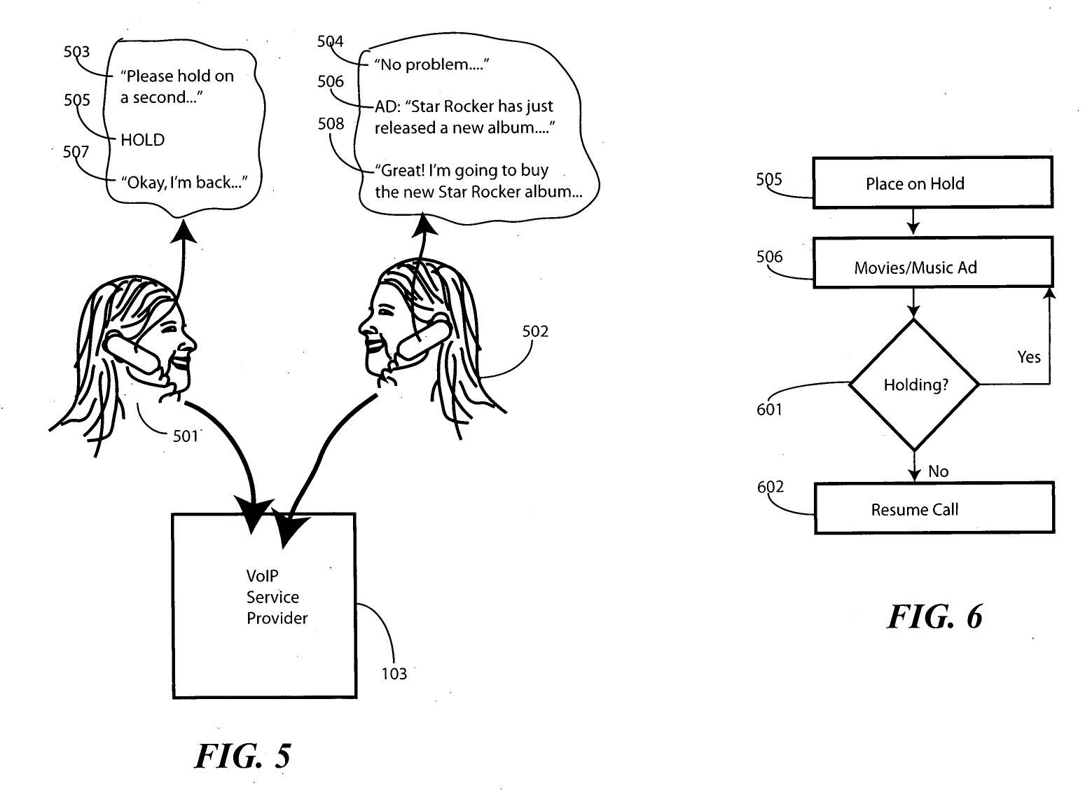

Turning now to FIG. 5, illustrated therein is a call interruption in accordance with embodiments of the invention. The call interruption may be due to any of a variety of reasons, including a party placing a caller on hold, a party receiving a second call via a call waiting feature, a three-way call, and the like. In the illustrative embodiment of FIG. 5, presume that caller 501 wants to place caller 502 on hold momentarily.

At 503, caller 501 tells caller 502 that he is to be put on hold. For instance, caller 501 may say, “Would you mind holding for just a minute?” Caller 502 may acknowledge this request at 504, perhaps by saying, “No, I don't mind at all.”

Caller 501 then places caller 502 on hold at 505. While caller 502 is on hold, she may hear non-targeted advertising 506, such as the latest music or movie releases. Once caller 501 releases the hold and acknowledges his return at 507, the call proceeds. Caller 502 may begin the conversation again at 508.

Turning now to FIG. 6, illustrated therein is a flow chart indicating the steps that may occur in accordance with the invention for a call interruption, such as the one shown in FIG. 5. At step 505, one caller (501) places another caller (502) on hold. At step 506, the caller (502) on hold hears non-targeted advertising. At decision 601, the service provider (103) determines whether the call is still on hold. Where it is, the caller (502) on hold may continue to hear advertising. Once the call is no longer on hold, the service provider (103) completes the call at step 602.

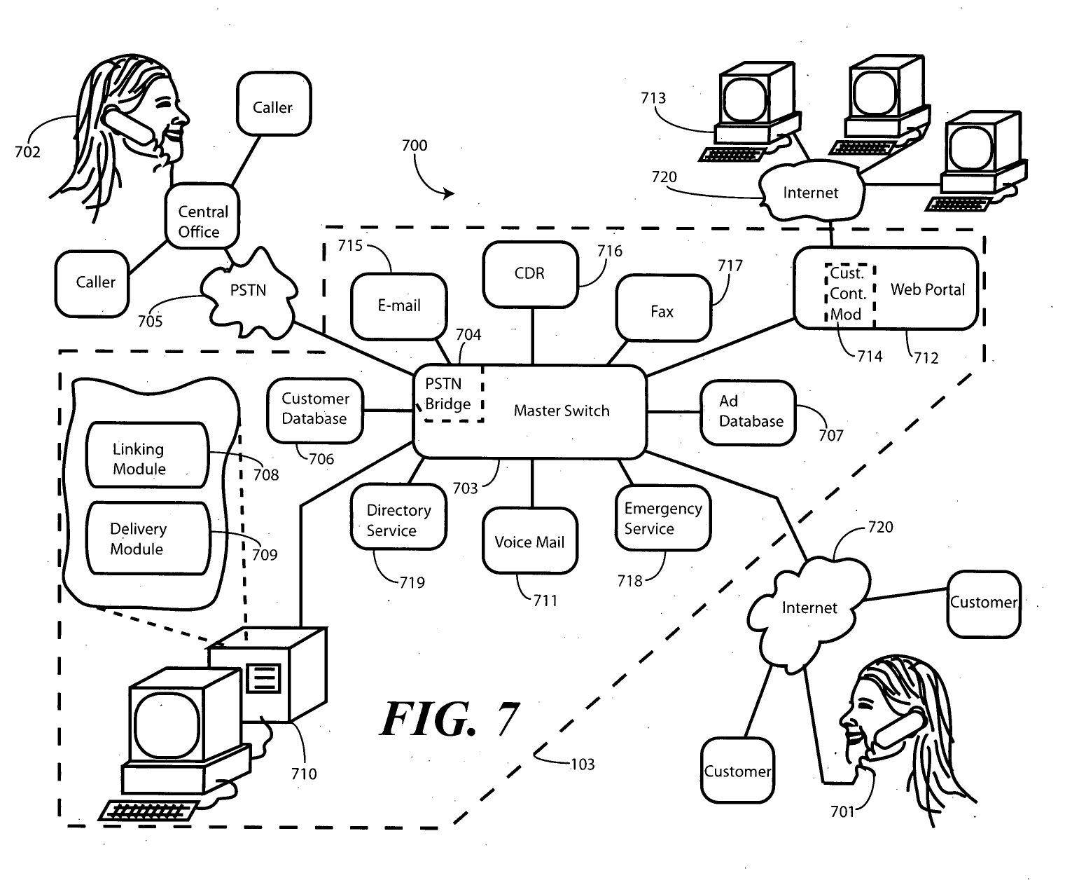

Turning now to FIG. 7, illustrated therein is a system 700 for providing telecommunication services free of charge, like those discussed in FIGS. 1-6, to a plurality of customers in accordance with the invention. In one embodiment of the invention, the service provider 103 is configured to accommodate voice calls across a Voice over Internet Protocol network. Voice over Internet Protocol networks are well known in the art. For example, U.S. Pat. No. 6,836,804, entitled “VoIP Network”, which is incorporated herein by reference, teaches such a system. Voice over Internet Protocol systems are convenient for methods and systems in accordance with the present invention because they often include lower overhead costs and can accommodate multiple communications modes, including voice, data, multimedia, e-mail, and facsimile communications. It will be clear to one of ordinary skill in the art having the benefit of this disclosure, however, that a Voice over Internet Protocol system is not a prerequisite for effecting the invention. Other systems, including traditional, copper-based systems, may also be used. For discussion purposes herein, a hybrid system capable of accommodating both Voice over Internet Protocol communications and traditional, analog communications will be used.

In FIG. 7, a service provider 103 has a master switch 703 capable of establishing telecommunication channels between a destination caller 702 and a source 701. The master switch 703 serves as the communications gateway between various callers. As is known in the art, the master switch 703 includes several ingress ports and ingress functions, which may include data processing, filtering, and encoding. Similarly, the master switch 703 includes several egress ports and egress functions. The master switch 703 may be under the control of a central computer, so that the various hardware functions may be controlled, configured, or optimized.

As the service provider is suited to accommodate either traditional, analog communications or Voice over Internet Protocol communications, the master switch 703 may be coupled to multiple networks. For example, the master switch 703 may be coupled both to a public switched telephone network and to computer data networks, such as the Internet 720. To couple to these networks, the master switch 703 may include a Public Switched Telephone Network bridge 704 for converting the packetized, digital, Voice over Internet Protocol communications to analog public switched telephone network communications and vice versa. One example of such a public switched telephone network bridge 704 is the TDM400P Four Port TI card configured to run with Asterisk software to couple a voice over Internet protocol switch to a public switched telephone network. Other similar cards are manufactured Digium, Inc.

As noted above, in one embodiment of the invention the offer for free of charge telecommunications service is contingent upon a prospective customer delivering personal interest information so that he may receive targeted advertising when placing or receiving calls. To store such customer personal interest information, a customer database 706 is coupled to the master switch 703. The customer database 706 has stored therein a plurality of telephone numbers corresponding to a plurality of customers. In addition to the plurality of telephone numbers, each telephone number has customer personal interest information associated therewith and stored in the customer database 706. As such, when a customer 701 places a call, the service provider 103 may reference this personal interest information with targeted advertising for delivery.

An advertising database 707 coupled to the master switch 703 stores the advertising information. Both targeted and non-targeted advertisements may be stored in the advertising database 707. Targeted advertising may be delivered, for instance, to a customer 701 making an outbound call, while non-targeted advertising may be delivered to a non-customer caller 702 making an inbound call. The advertising database 707 has stored therein a plurality of advertisements. Where the advertisements are targeted, the advertisements include a personal interest association. For example, where the customer 701 likes to snack on donuts, an ad for donuts may include that personal interest association so as to be delivered to donut eaters and not those on diets.

A linking module 708, which may be a software module operating on a computer or server 710 coupled to the master switch 703, is operable with the master switch 703 to ensure that the proper advertisements reach the proper callers. In one embodiment for example, when an outbound call is received from a customer 701 by the master switch 703, the linking module 708 is configured to determine the origination telephone number associated with the customer 701, who is the source of the outbound call. The linking module 708 then references the customer database 706 to determine at least one piece of customer personal interest information that is associated with the origination telephone number. For example, where the customer 701 provided ten pieces of recreation information, ten pieces of hobby information, and ten pieces of occupational information, the linking module 708 may randomly select one of these pieces of personal interest information.

A delivery module 709, which may also be a software module operating on a computer or server 710 coupled to the master switch 703, is operable with the master switch 703 to select an advertisement having a target personal interest association corresponding to the selection of customer personal interest information. Continuing with the donut example, where the piece of customer personal interest information selected by the linking module 708 is the fact that the customer 701 likes to snack on donuts, the delivery module may select an audio advertisement having persons who like donuts as the target personal interest association. The delivery module 709 then delivers the target advertisement, i.e. the advertising having the target personal interest association corresponding to the selection of the personal interest information, to the source of the outbound call. This delivery occurs prior to the master switch 703 completing the call between the customer 701 and the destination caller 702.

A voice mail server 711 is coupled to the master switch 703 and may be used for storing audible voice mail messages when customer lines are busy or unavailable. For example, when a call is directed to a customer, and the customer is not home, after a predetermined number of rings, the master switch 703 may deliver the call to a voice mailbox on the voice mail server 711 associated with the customer. The incoming caller may then leave a message for the customer that is retrievable at a later time.

When the customer then calls in to retrieve the message, in one embodiment they must listen to a targeted advertisement prior to retrieving any messages. Thus, if customer 701 calls into the voice mail server 711 to retrieve messages, prior to connecting the call to the voice mail server 711, the delivery module 709 may select an advertisement from the advertising database 707 on the advertising server for delivery to the customer 701. Alternatively, the linking module 708 may first determine the number associated with the inbound call so the delivery module 709 may select a targeted advertisement for delivery to the source of the inbound call prior to connecting the call with the voice mail server 711.

Alternatively, the service provider may deliver a number of advertisements to the customer's voice account in the voice mail server 711. The number of ads delivered may a percentage of the number of messages stored in the account. For example, for every five messages received by the customer 701, the user may receive one advertisement. Thus, rather than listening to an advertisement prior to retrieving messages, the customer 701 may listen to advertisements while retrieving messages. In such an embodiment, the delivery module 709 may select an advertisement from the advertising database 707 and deliver the advertisement to a customer account within the voice mail server 711.

When a caller outside the customer base, e.g. caller 702, makes an inbound call to a customer, e.g. customer 701, the delivery module 709 selects a non-targeted advertisement from the advertising database 707. The delivery module 709 then delivers the non-targeted advertisement to the source of the inbound call, i.e. caller 702, prior to completing the call to the customer 701. This is similar to the process set forth in FIG. 3.

The system 700 may include a web portal 712 operable with the customer database 706. With the popularity of Internet-based commerce, the service provider 103 may elect to offer the service over the Internet, perhaps via a page on the World Wide Web. As such, the web portal 712 may be coupled to the Internet 720 and then to various client terminals 713. Customers may request service by completing an application and questionnaire including personal interest information over the internet.

The web portal 712 may also include a customer control module 714 that is operable with the customer database 706. The customer control module 714 stores the personal interest information received from prospective customers in the customer database 706. For instance, upon the web portal receiving a request for service from a prospective customer, where the request for service includes a completed questionnaire having the prospective customer's personal interest information therein, the customer control module 714 would then store the personal interest information in the customer database 706. The customer control module 714 may include other functions, including assignment of identifiers—like telephone numbers—that may be deliverable via the web portal 712.

Additionally, the web portal 712 may be accessible by advertisers and customers to retrieve data. For example, a customer 701 wishing to get billing or account information, or wishing to edit this information, may log in through the web portal 712. Similarly, an advertiser may log in through the web portal 712 to determine how many of his advertisements have been delivered, when they were delivered and other similar information.

The system 700 may include other elements for additional services. For instance, an e-mail server 715 may provide e-mail services to the customers. A call detail records database 716 may include records relating to call times and destinations for billing. A facsimile server 717 may be included to provide facsimile services. An emergency server 718 may be included to accommodate emergency calls to local authorities. A directory service or information server 719 may be included for directory assistance services.

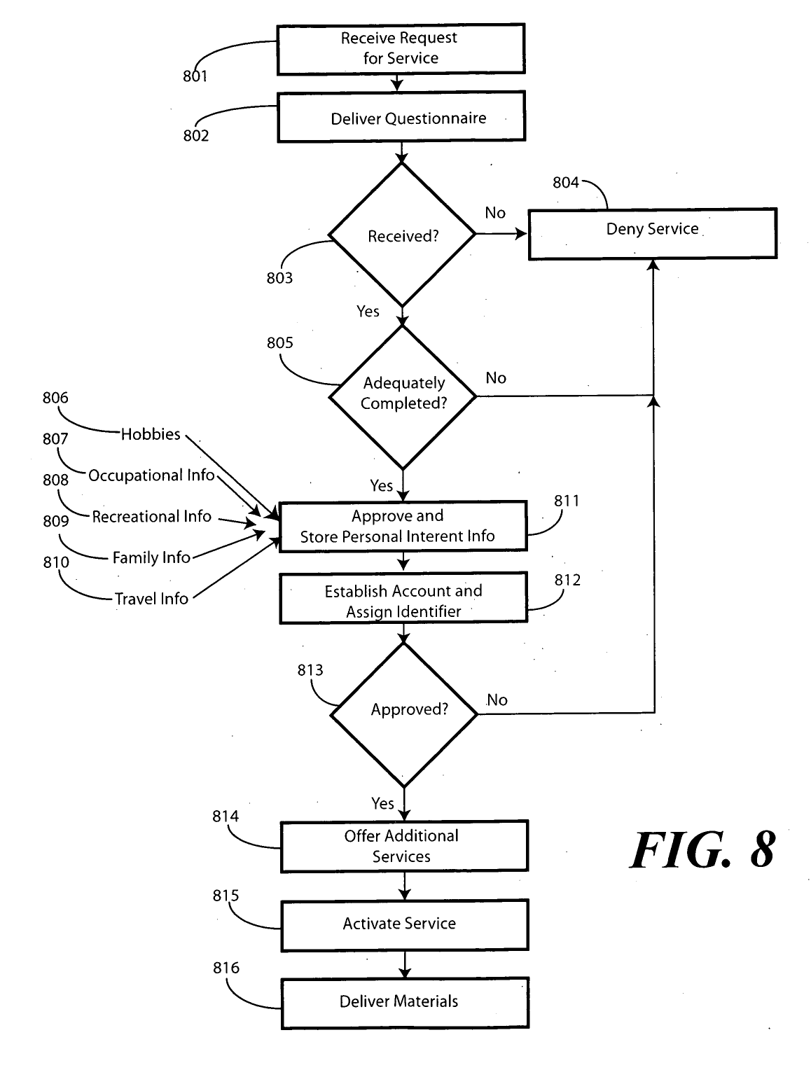

Turning now to FIG. 8 illustrated therein is one embodiment for a method of offering and establishing free of charge telecommunication services with a customer in accordance with the invention. The method of FIG. 8, for example, may be used in conjunction with the web portal (712) of FIG. 7. The method facilitates offering telecommunication services at no charge to the customer, as the costs of operating the service are paid by advertising entities. The advertising entities are able, in one embodiment, to deliver targeted advertising to the customers of the free of charge telecommunication services.

At step 801, the service provider (103) receives a request from the customer for telecommunication services capable of facilitating voice communications. In one embodiment of the invention, the telecommunication services are Voice over Internet Protocol communication services, public switched telephone network communication services, or a hybrid combination thereof. As noted above, this request for services may be received by way of the web portal (712).

In one embodiment of the invention, as the telecommunications are provided free of charge, acceptance of the request for service is contingent upon the customer completing a customer profile comprising at least personal interest information. This customer profile may be completed by a questionnaire that includes questions relating to customer personal interest information. The personal interest information may include any of hobby information, occupational information, recreational information, family information, travel preference information and consumer information. Other types of personal interest information will be obvious to those of ordinary skill in the art having the benefit of this disclosure. The questionnaire is delivered to the customer at step 802.

At decision 803, the service provider (103) checks to see whether the questionnaire has been received. Where it has not, as in this embodiment the offer was contingent upon receipt, the service may be denied at step 804.

Where the questionnaire has been received, the service provider (103) may check to see if the questionnaire has been adequately completed at decision 805. This check may include reviewing the answers to ensure that they are sensible, so as to perhaps prohibit an automated machine from randomly filling in the questionnaire. Additionally, the service provider (103) may check to see if enough of the questions have been answered. Since one embodiment of the invention includes delivering targeted advertising, where the questionnaire is not adequately completed, the service provider (103) may not be able to properly deliver such advertising. In this case, the step of approving the customer for telecommunication services occurs only after a completed customer profile has been received. Where a completed customer profile is not received, the service provider (103) may deny service at step 804.

Where the customer profile meets the selected predetermined acceptance criterion, the service provider (103) may approve the services and store the personal interest information in the customer database (706) at step 804. The service provider (103) then establishes a telecommunication services account for the customer and assigns an identifier to the customer at step 812. Upon assigning an identifier, the personal interest information may be associated with the customer, the identifier, or both in the database. Where the customer is applying for telephone service, the identifier may be a ten-digit telephone number assigned to the customer.

Confirming that the account has been approved at decision 813, the service provider (103) may offer additional services to the customer at step 814. Thus, upon completion of the step of approving the customer for telecommunication services 812, the customer may be offered an additional telecommunication service feature or features. These features may be any selected from the group consisting of voice mail services, electronic mail services, caller identification services, facsimile services, multiple identifier services, multiple telephone line services, virtual concierge, enhanced caller directory, international calling services, and call waiting services. Of course other features may be added as well. Other features that may be offered at step 814 will be obvious to those of ordinary skill in the art having the benefit of this disclosure.

Service is then activated at step 815. A welcome package or other materials are then delivered to the customer at step 816. The welcome package may include an introductory letter and greeting to the customer. The welcome package may also include an actuation package having instructions for using the various services offered. Where the service requires hardware, as may be the case in a Voice over Internet Protocol system, the actuation package may include the hardware required. For example, if a converter box is required to convert the analog signals coming from a traditional telephone into switched packet data suitable for a Voice over Internet Protocol system, the actuation package may include the converter box and associated connectors, power supplies, and accessories.

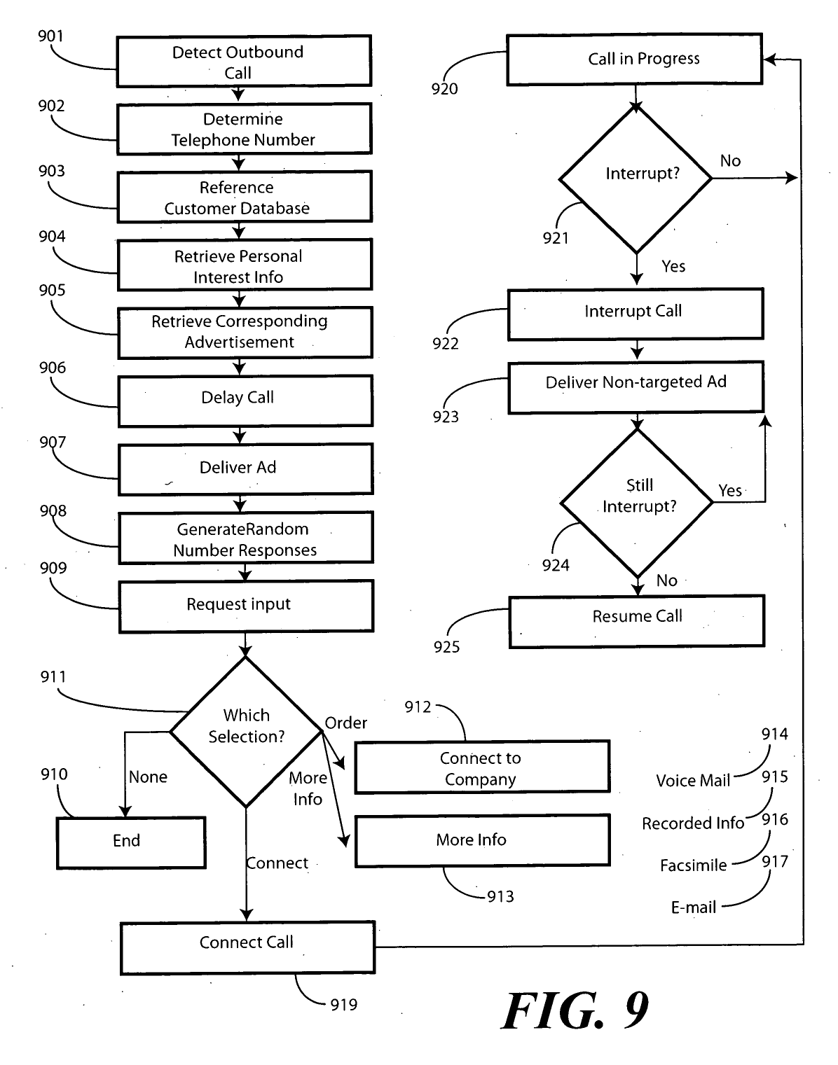

Turning now to FIG. 9, illustrated therein is one method for a service provider (103) to complete a free of charge, outbound voice communication channel in accordance with the invention. Recall that FIG. 1 illustrated one such call. FIG. 9 illustrates a flow chart that may be executed by way of software operating on a computer or other server for accomplishing such a call.

At step 901, an outbound call is detected. At step 902, in response to the initiation of the outbound telephone call, the system determines the origination telephone number associated with the source of the outbound call. This determination may be accomplished with a linking module (708) as discussed with respect to FIG. 7.

At step 903, the system references the database having the origination telephone number stored therein. With a system structured in accordance with FIG. 7, this database is the customer database (706). As the customer originating the call has completed a questionnaire with personal interest information, the origination telephone number is associated with the personal interest information belonging to the customer in the database. Thus, by determining the origination telephone number, the system is able to cross-reference and retrieve the personal interest information belonging to the customer originating the call at step 904.

Upon retrieval of the personal interest information, the system then selects from a plurality of advertisements. In one embodiment, the advertisements are stored in an advertising database (707), and at least some of the advertisements include a targeted personal interest association. By correlating the targeted personal interest association with the personal interest information, the system is able to deliver a targeted advertisement to the customer. In one embodiment, a delivery module (709) selects an advertisement having a target personal interest association that corresponds to the personal interest information.

At step 906, the outbound call is delayed for at least a predetermined time. The delay offers the system the opportunity to deliver the selected advertisement to the source of the outbound call. The system delivers this advertisement corresponding to the personal interest information to the source of the outbound call at step 907.

At step 909, the system prompts the source of the outbound call for a response. This response may be selected at random by the system at step 908 to ensure that the advertisement delivered at step 907 is not prematurely terminated. One or more options with corresponding responses may be offered at step 909. For example, the system may ask the source of the outbound call to press or say a particular number to complete the call. Additionally, the system may ask the source of the outbound call to press or say another number to receive more information relating to a product or service featured in the commercial. Further, the system may ask the source of the outbound call to say or press yet another number to place orders for the product or service featured in the call. Where a plurality of options is offered, the system determines which response is received at decision 911.

In one embodiment, at step 909 the system prompts the source of the outbound telephone call with an option to obtain additional information related to the advertisement corresponding to the personal interest information. The response requested may be by pressing a button to generate a dual tone multi-frequency input. Alternatively, the response requested might be a voice input in response to the prompting step 909. Where the system determines that such a response is received at decision 911, the system delivers additional information relating to the delivered advertisement at step 913.

This additional information may be delivered in a variety of ways, the preferred mode of which is determined at decision 911. The additional information may be a recorded announcement 915 that is played to the source of the outbound call prior to completing the outbound call. The recorded announcement 915 would have additional information therein relating to the product or service featured in the advertisement.

The additional information may alternatively be a voice mail message 914 delivered to a voice mail account belonging to the source of the outbound calls. Further, the additional information may be a facsimile message 916 delivered to the source's facsimile machine or e-mail account. The additional information may be an e-mail 917 delivered to the source of the outbound call. E-mailed information may include audio, video, or other multimedia advertising. The additional information may also be a Voice over Internet Protocol call to the source at a later time. Other forms of delivery will be clear to those of ordinary skill in the art having the benefit of this disclosure.

In one embodiment, at step 909 the system prompts the source of the outbound telephone call with an option to be connected via an accessible communication channel to a company, vendor, or retailer related to the advertisement corresponding to the personal interest information. The response requested may be by pressing a button to generate a dual tone multi-frequency input, and may occur only after the step of delivering the advertisement 907 is completed. Alternatively, the response requested might be a voice input in response to the prompting step 909. Where the system determines that such a response is received at decision 911, the system may connect the source of the outbound call to a retailer or company associated with the advertisement at step 912. The source may then place orders, or ask additional questions, about the product or service featured in the advertisement.

In one embodiment, at step 909 the system prompts the source of the outbound telephone call with an option to obtain complete the outbound call by establishing a communication channel between the source and destination. As with the previous paragraphs, the response requested may be by pressing a button to generate a dual tone multi-frequency input. Alternatively, the response requested might be a voice input in response to the prompting step 909. The response may be requested only after the step of delivering the advertisement 907 is completed. Where the system determines that such a response is received at decision 911, the system completes the call at step 919.

While the call is in progress 920, various interrupts may occur. A caller may place another caller on hold, a third party may call in, and so forth. The system checks to see if an interrupt is received at decision 921. Upon receiving a telecommunication channel interrupt request from the source of the outbound call at step 922, the system temporarily interrupts the telecommunication channel. Specifically, either the destination of the call or the source of the call will be put on hold and momentarily disconnected from the other party.

During this time, the system may deliver non-targeted advertising to the party on hold at step 923. This non-targeted advertising, in one embodiment, includes information relating to musical productions, such as new album or song releases. The non-targeted advertising may also be related to cinematographic productions, such as new movie releases. The system checks to see whether the interrupt is ongoing at decision 924. Where it is not, the call is resumed at step 925.

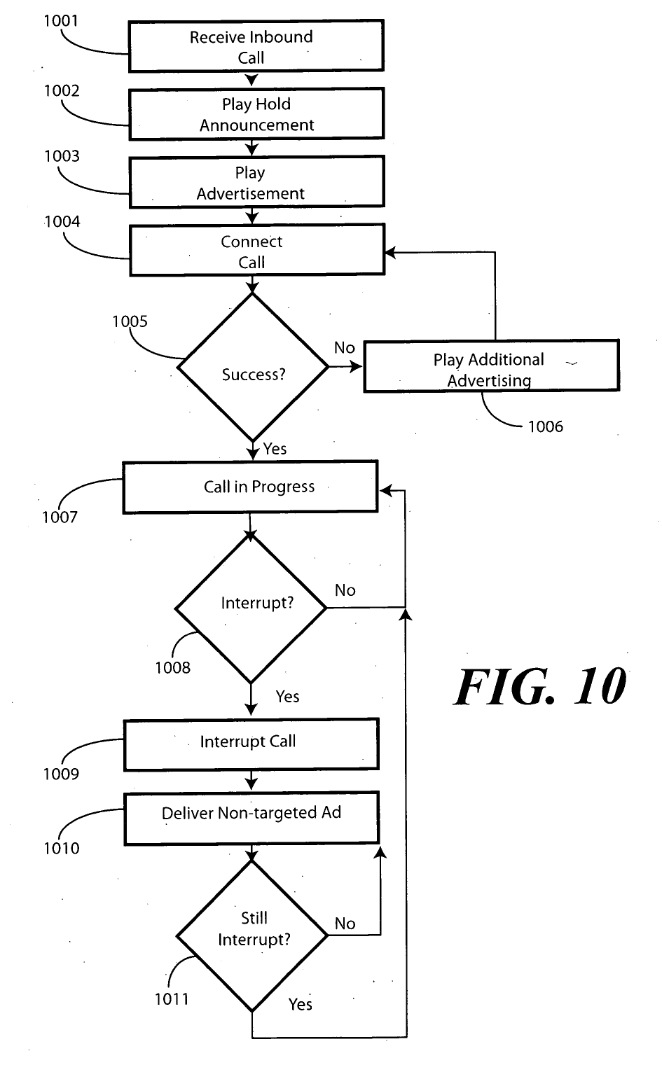

Turning now to FIG. 10, illustrated therein is one method for a service provider (103) to complete an inbound call or voice communication channel directed to a customer receiving free of charge telecommunication services in accordance with the invention. Recall that FIG. 3 illustrated one such call. FIG. 10 illustrates a flow chart that may be executed by way of software operating on a computer or other server for accomplishing such a call.

At step 1001, an incoming call is received and intercepted. Where the free of service telecommunication services are Voice over Internet Protocol services, the destination of the inbound call operates on a Voice over Internet Protocol network. The source of the inbound call may or may not be on a Voice over Internet Protocol system. Thus, the inbound call may be received from either a public switched telephone network or a Voice over Internet Protocol network.

A prerecorded message is delivered to the source of the inbound telephone call at step 1002. The prerecorded message may say something like, “Please hold while we attempt to complete your call.” Upon completion of step 1002, advertising content of a predetermined duration is delivered to the source of the inbound telephone call at step 1003. As the inbound call is not coming from a customer, the personal interest information of the caller may not be known. Thus the advertisement delivered at step 1003 may be non-targeted advertising.

Once the predetermined duration has elapsed, and the advertisement is completed, the system attempts to establish a telecommunication channel between the destination of the inbound call and the source of the inbound call at step 1004. The system checks to see whether the attempt was successful at decision 1005. The attempt may be unsuccessful, for example, if the destination was busy or unavailable.

Where the attempt is unsuccessful, for example where the destination of the inbound telephone call is occupied, the system delivers non-targeted advertising to the source of the inbound call at step 1006. This non-targeted advertising, in one embodiment, includes information relating to musical productions, such as new album or song releases. The non-targeted advertising may also be related to cinematographic productions, such as new movie releases. While the advertisement is playing, the system may continue to attempt to make a connection with the destination of the inbound call. Where possible, the call is established at step 1007.

As with the outbound call, once the call is in progress, various interrupts may occur. At decision 1008, the system checks to see whether an interrupt is received. Where a telecommunication channel interrupt is received, the system interrupts temporarily the telecommunication channel at step 1009. During the interrupt, non-targeted advertising is delivered to the party on hold. This non-targeted advertising may be one of information relating to musical productions, information relating to cinematographic productions, or other forms of advertising.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A method for establishing telecommunication services with a customer at no charge to the customer, the method comprising the steps of:
a. receiving a request from the customer for telecommunication services capable of facilitating voice communications, wherein acceptance of the request is contingent upon the customer completing a customer profile comprising at least personal interest information;
b. receiving the customer profile;
c. where the customer profile meets at least a predetermined criterion, approving the customer for the telecommunication services;
d. establishing a telecommunication services account for the customer; and
e. transmitting an actuation package to the customer.

2. The method of claim 1, wherein the step of approving the customer for telecommunication services occurs only after a completed customer profile has been received.

3. The method of claim 2, wherein upon completion of the step of approving the customer for telecommunication services, further comprising the step of offering an additional telecommunication service feature, wherein the additional telecommunication service feature is selected from the group consisting of voice mail services, electronic mail services, caller identification services, facsimile services, multiple identifier services, multiple telephone line services, virtual concierge, enhanced caller directory, international calling services and call waiting services.

4. The method of claim 1, further comprising the steps of:
a. assigning an identifier to the customer; and
b. storing the personal interest information in a database, wherein the personal interest information is associated with one of the customer and the identifier in the database.

5. The method of claim 1, wherein the personal interest information is selected from the group consisting of hobby information, occupational information, recreational information, family information, travel preference information and consumer information.

6. The method of claim 4, wherein the telecommunication services comprise one of voice over Internet protocol communication services and public switched telephone network communication services, further wherein the identifier comprises a ten-digit telephone number.

7. A method of establishing a free of charge voice communication channel telecommunication system, the method comprising the steps of:
a. in response to an initiation of an outbound telephone call, determining a origination telephone number associated with a source of the outbound telephone call;
b. referencing a database having the origination telephone number stored therein, wherein the origination telephone number is associated with personal interest information;
c. selecting from a plurality of advertisements an advertisement corresponding to the personal interest information;
d. delaying the outbound telephone call for at least a predetermined time; and
e. delivering the advertisement corresponding to the personal interest information to the source of the outbound telephone call.

8. The method of claim 7, further comprising the steps of:
a. prompting the source of the outbound telephone call with an option to obtain additional information related to the advertisement corresponding to the personal interest information;
b. receiving one of a dual tone multi-frequency input and a voice input in response to the step of prompting; and
c. delivering additional information related to the advertisement corresponding to the personal interest information to the source of the outbound telephone call.

9. The method of claim 8, wherein the additional information related to the advertisement corresponding to the personal interest information comprises an accessible communication channel with a vendor associated with the advertisement corresponding to the personal interest information.

10. The method of claim 8, wherein the additional information related to the advertisement corresponding to the personal interest information comprises a recorded announcement having the additional information therein.

11. The method of claim 8, wherein the additional information related to the advertisement corresponding to the personal interest information comprises a voice mail message delivered to a voice mail account associated with the source of the outbound telephone call.

12. The method of claim 8, wherein the additional information related to the advertisement corresponding to the personal interest information comprises a facsimile message having the additional information therein.

13. The method of claim 7, wherein the outbound telephone call comprises a voice over Internet protocol telephone call.

14. The method of claim 7, further comprising the steps of:
a. prompting the source of the outbound telephone call for a response upon delivery of advertisement corresponding to the personal interest information;
b. receiving one of a dual tone multi-frequency input and a voice input in response to the step of prompting; and
c. completing the outbound call by establishing a communication channel between the source and a destination.

15. The method of claim 14, wherein the step of prompting the source of the outbound telephone call for a response occurs only after the step of delivering the advertisement corresponding to the personal interest information is completed, further wherein the step of prompting the source of the outbound telephone call for a response comprises requesting a caller to enter one of a dual tone multi-frequency input and a voice input, wherein the one of a dual tone multi-frequency input and a voice input requested is selected at random.

16. The method of claim 7, further comprising the steps of:
a. receiving a telecommunication channel interrupt request from one of the source and a destination of the outbound telephone call;
b. interrupting temporarily the telecommunication channel between the destination and the source of the outbound telephone call; and
c. delivering additional advertising to at least one of the destination and the source of the outbound telephone call.

17. The method of claim 16, wherein the additional advertising comprises information relating to one of musical productions and cinematographic productions.

18. A method of establishing a voice communication channel from a public switched telephone network to a voice over Internet protocol telecommunication system, the method comprising the steps of:
a. intercepting an inbound telephone call from the public switched telephone network directed to a voice over Internet protocol destination, wherein the voice over Internet protocol destination receives free of charge telecommunication services;
b. delivering a prerecorded message to a source of the inbound telephone call;
c. delivering advertising content of a predetermined duration to a source of the inbound telephone call; and
d. once the predetermined duration has elapsed, attempting to establish a telecommunication channel between the destination and the source of the inbound telephone call.

19. The method of claim 18, wherein when the destination of the inbound telephone call is occupied, further comprising the step of delivering additional advertising to the source of the inbound telephone call.

20. The method of claim 19, wherein the additional advertising comprises information relating to one of musical productions and cinematographic productions.

21. The method of claim 18, further comprising the steps of:
a. establishing the telecommunication channel between the destination and the source of the inbound telephone call;
b. receiving a telecommunication channel interrupt request from one of the destination and the source of the inbound telephone call;
c. interrupting temporarily the telecommunication channel between the destination and the source of the inbound telephone call; and
d. delivering additional advertising to one of the destination and the source of the inbound telephone call.

22. The method of claim 21, wherein the additional advertising comprises information relating to one of musical productions and cinematographic productions.

23. A system for providing telecommunication services free of charge to a plurality of customers, the system comprising:
a. a master switch capable of establishing telecommunication channels between a destination and a source, the master switch being coupled to one of the Internet and both the Internet and a public switched telephone network;
b. a customer database coupled to the master switch, wherein the customer database has stored therein a plurality of telephone numbers corresponding to the plurality of customers, wherein each of the plurality of telephone numbers has customer personal interest information associated therewith;
c. an advertising database coupled to the master switch, wherein the advertising database comprises a plurality of advertisements, each of the plurality of advertisements having a target personal interest association; and
d. a linking module operable with the master switch, wherein when an outbound call is received by the master switch, the linking module determines an origination telephone number associated with a source of the outbound call and references the customer database to determine at least one selection of the customer personal interest information associated with the origination telephone number; and
e. a delivery module operable with the master switch, wherein the delivery module selects an advertisement having a target personal interest association corresponding to the at least one selection of the customer personal interest information from the advertising database, and delivers the advertisement having the target personal interest association corresponding to the at least one selection of the personal interest information to the source of the outbound call prior to completing the outbound call.

24. The system of claim 23, further comprising a voice mail server operable with the master switch and configured to store a plurality of audible messages, wherein prior to connecting an inbound call to the voice mail server, the delivery module selects an advertisement from the advertising database and delivers the advertisement to a source of the inbound call.

25. The system of claim 23, further comprising a voice mail server operable with the master switch and configured to store a plurality of audible messages, wherein the delivery module selects an advertisement from the advertising database and delivers the advertisement to a customer account within the voice mail server.

26. The system of claim 23, wherein upon the master switch receiving an inbound call directed to at least one of the plurality of customers, the delivery module selects an advertisement from the advertising database and delivers the advertisement to a source of the inbound call.

27. The system of claim 23, wherein the master switch comprises one of a voice over Internet protocol device and a voice over Internet to public switched telephone network bridge.

28. The system of claim 23, further comprising a web portal operable with the customer database and a customer control module operable with the customer database, wherein upon the web portal receiving a request for service comprising at least personal interest information, the customer control module stores the at least personal information in the customer database and assigns an identifier deliverable by the web portal.
